(19) United States
(12) Patent Application Publication
(10) Pub. No.: US 2004/0035876 A1
(43) Pub. Date: Feb. 26, 2004

(54) Apparatus for dispensing articles

(75) Inventor: Julian B. Lo, Old Lyme, CT (US)

Correspondence Address: PFIZER INC., PATENT DEPARTMENT, MS8260-1611, EASTERN POINT ROAD, GROTON, CT, 06340, US

(73) Assignee: Pfizer Inc

(21) Appl. No.: 10/645,108

(22) Filed: Aug. 21, 2003

Related U.S. Application Data
(60) Provisional application No. 60/405,641, filed on Aug. 23, 2002.

(51) Int. Cl. G07F 11/66; G07F 11/00

(52) U.S. Cl. 221/25; 221/79

(57) ABSTRACT

An apparatus for dispensing articles is provided which comprises a housing for retaining a circular, or substantially circular, medicament container, wherein the housing comprises a dispensing aperture registerable with a single medicament cell of the medicament container; and means for locking the medicament container in a locked, non-rotating dispensing position; wherein the medicament container comprises a plurality of medicament cells containing contents to be dispensed, and is moveable between a freely rotatable, non-dispensing position and the locked, non-rotating dispensing position such that when the medicament container is in the freely rotatable, non-dispensing position, the single medicament cell is out of registry with the dispensing aperture of the housing, and when the medicament container is in the locked, non-rotating dispensing position, the single medicament cell and the dispensing aperture of the housing are in registry, such that only contents contained in the single medicament cell may be dispensed therethrough.

### CROSS REFERENCE TO RELATED APPLICATION

This application claims the benefit of U.S. Provisional Application No. 60/405,641 filed Aug. 23, 2002.

### BACKGROUND OF THE INVENTION

The pharmaceutical industry offers a diverse array of dispensers and containers for medications. While governmental regulations require child-resistant caps on bottles and vials containing pharmaceutical products, there exists a general need in the art for a device that is not only child-resistant, but also permits access to the medicaments or other articles contained therein to persons of diminished dexterity or cognitive function.

In recent years, blister packaging has become universally preferable, not only for medicaments in the form of capsules, pills or lozenges, but also for various electronic and automotive parts and the like. In a conventional blister package dispenser, the articles to be dispensed are sandwiched between a layer of transparent or translucent plastic in the form of a generally outwardly extending cavity or blister cell and a rupturable or puncturable layer. Force applied to the exterior of the outwardly extending blister cell, for example by the pressure of one or more fingers or the thumb of the individual dispensing the article, is transmitted to the article contained therein which subsequently ruptures or punctures the rupturable or puncturable layer. The article may then be removed or otherwise dispensed from the blister cell by the user.

Because the contents of a blister package are generally visible and sometimes highly colored, they can become the targets of inquisitive children who risk substantial injury and/or death if they succeed in opening the package and ingesting or mishandling the contents therein. Accordingly, it is important to childproof such packaging by rendering them too difficult to open for children while concurrently providing a user-friendly apparatus for use by adults of diminished dexterity, or cognition.

Child-resistant blister packages comprise a diversity of arrangements well-known to those of ordinary skill in the art. For example, U.S. Pat. No. 5,150,793 discloses a blister-type package dispenser comprising a moveable rectangular blister package retained in a housing having a plurality of dispensing apertures. In such packaging, the pills or medicaments cannot be dispensed from the apparatus unless, or until, the blister cells containing the articles to be dispensed are brought into registry with the dispensing apertures of the housing, an action that is typically accomplished by sliding the blister package between dispensing and non-dispensing positions. Unfortunately, the aforementioned device suffers from the salient disadvantage of requiring multiple dispensing apertures where the dispensing of more than a single pill or medicament from the blister package is desired. Such an arrangement further permits the unintentional, and/or undesirable, dispensation of multiple pills or medicaments in a single operation of the device, an attribute clearly detrimental to rendering the device child-resistant. Related examples of such blister packages are disclosed in, inter alia, U.S. Pat. Nos. 5,244,901; 4,905,866; 4,817,819; and 4,511,032. The disclosures of the aforementioned U.S. patents are all incorporated herein in their entirety by reference.

The instant invention is directed to an improved, child-resistant medicament container which overcomes the disadvantages of the aforementioned prior art devices by providing an apparatus comprising a preferred circular, or substantially circular, medicament container comprising a plurality of medicament cells preferably containing contents to be dispensed and retained in a housing having a single dispensing aperture. The medicament container is rotatably mounted in, or on, the housing about a common axis such that the medicament container may be moved between a freely rotatable, non-dispensing position, and a locked, non-rotating dispensing position. By providing such housing having a single dispensing aperture and means for locking the medicament container in a locked, non-rotating dispensing position, only contents contained in a single medicament cell may be dispensed through the dispensing aperture in a single operation of the device, even though the medicament container incorporates a plurality of medicament cells containing contents to be dispensed.

### SUMMARY OF THE INVENTION

An apparatus for dispensing articles is provided which comprises a housing for retaining a circular, or substantially circular, medicament container, wherein the housing comprises a dispensing aperture registerable with a single medicament cell of the medicament container; and means for locking the medicament container in a locked, non-rotating dispensing position; wherein the medicament container comprises a plurality of medicament cells containing contents to be dispensed, and is moveable between a freely rotatable, non-dispensing position and the locked, non-rotating dispensing position such that when the medicament container is in the freely rotatable, non-dispensing position, the single medicament cell is out of registry with the dispensing aperture of the housing, and when the medicament container is in the locked, non-rotating dispensing position, the single medicament cell and the dispensing aperture of the housing are in registry, such that only contents contained in the single medicament cell may be dispensed therethrough.

### BRIEF DESCRIPTION OF THE DRAWINGS

For a more complete understanding of the invention, reference is now directed towards the embodiments illustrated in greater detail in the accompanying drawings and described hereinbelow by way of examples of the invention.

In the drawings:

FIG. 1 is a perspective view of an exemplary embodiment of the apparatus of the invention.

FIGS. 1a to 1c depict fragmentary and cutaway perspectives showing operational details of the exemplary embodiment shown in FIG. 1.

FIG. 2 shows an alternative embodiment of the apparatus of the instant invention.

FIGS. 2a to 2c depict fragmentary and cutaway perspectives showing operational details of the exemplary embodiment shown in FIG. 2.

FIG. 3 shows an alternative embodiment of the apparatus of the instant invention.

FIGS. 3a to 3c depict fragmentary and cutaway perspectives showing operational details of the exemplary embodiment shown in FIG. 3.

### DETAILED DESCRIPTION OF THE INVENTION

The invention provides a child-resistant type medicament dispenser comprising a housing for retaining a medicament container, preferably a circular, or substantially circular blister package, preferably comprising a plurality of medicament cells containing contents to be dispensed, wherein the housing surrounds at least a portion of the medicament container and further comprises a dispensing aperture alignable and registerable with a single medicament cell of the medicament container, and means for locking the blister package while in a locked, non-rotating dispensing position.

The medicament container is moveable between a freely rotatable, non-dispensing position and a locked, non-rotating dispensing position such that when the medicament container is in the freely rotatable, non-dispensing position, the medicament cells are out of registry with the dispensing aperture of the housing, and when the medicament container is in the locked, non-rotating dispensing position, the dispensing aperture of the housing and a single blister cell of the medicament container are in registry. When the single blister cell of the medicament container and the dispensing aperture of the housing and are in registry, only contents contained in the single blister cell may be dispensed therethrough.

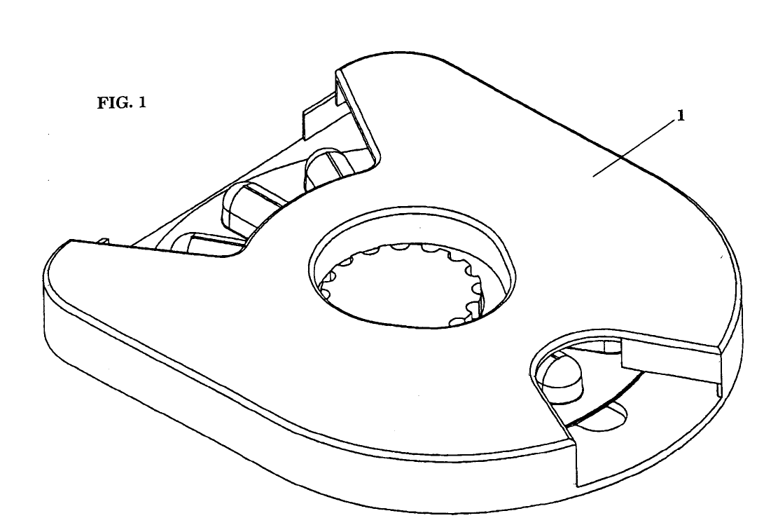

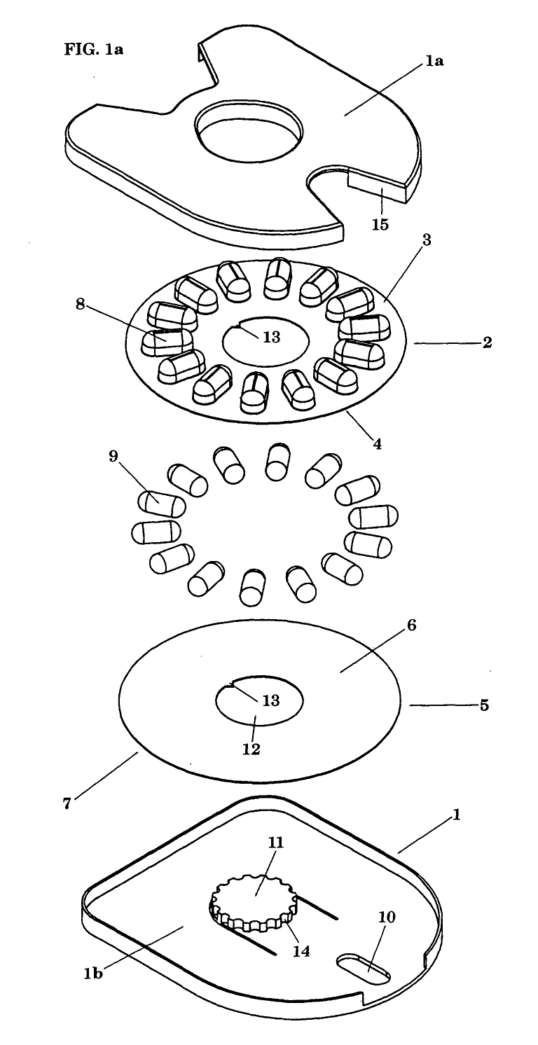

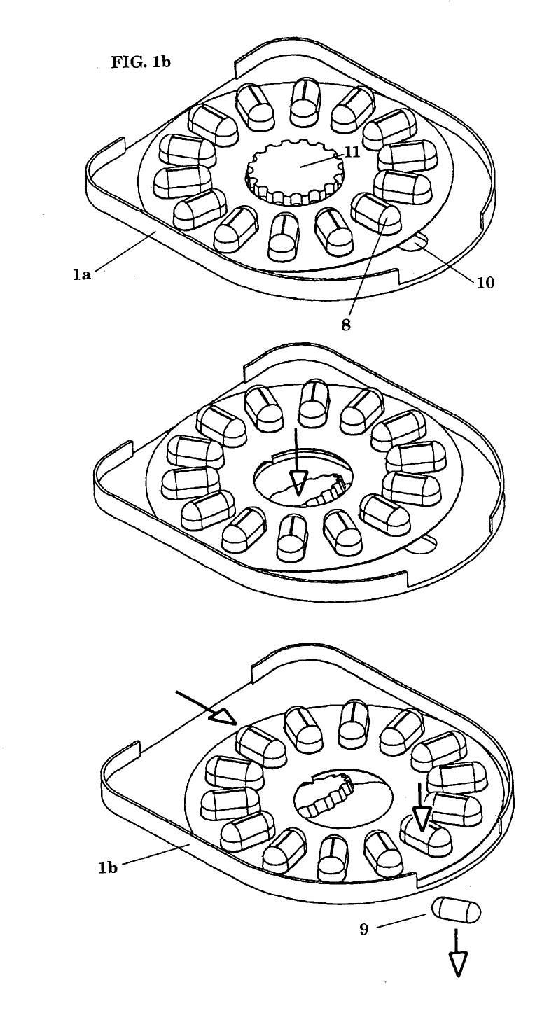

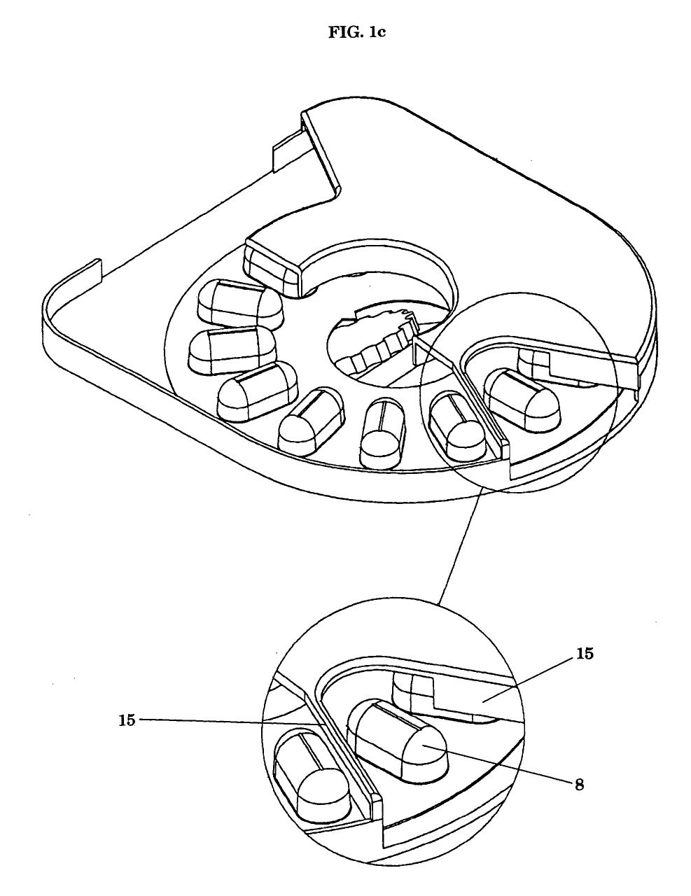

A first embodiment of the invention, which exemplifies certain generic elements and operational details of the present invention, is depicted in FIGS. 1, 1a, 1b, and 1c. It is to be understood, however, that the teachings hereinbelow with respect to the apparatus depicted in FIGS. 1, 1a, 1b, and 1c are presented solely for purposes of exemplification, and are not to be construed as limitations thereon as additional embodiments are, or will be, known or apparent in light of the instant disclosure, to one of ordinary skill in the art, including the alternative embodiments depicted hereinbelow.

The circular, or substantially circular, medicament container of the instant apparatus may comprise any suitable means known for retaining contents, preferably in the form of a solid articles 9, including, for example, simple, unsealed cavities that may be manually refilled by the user of the apparatus. The medicament container preferably comprises a conventional circular, or substantially circular, blister package unit that will be well known to one of ordinary skill in the art. As shown in the exemplary embodiment depicted in fragmentary perspective in FIG. 1a, such a conventional blister package typically comprises a first sheet 2, a second sheet 5, and articles 9 to be dispensed therefrom.

The first sheet 2 is formed from a generally compressible, formable material, preferably a clear, pre-formed polymeric or thermoplastic material such as polyvinyl chloride, polystyrene, polypropylene, polyethylene terephthalate (PET), polyethylene terephthalate glycol (PETG), or amorphous polyethylene terephthalate (APET), including laminates or co-extrusions thereof, which allows pressure applied to the first sheet 2 to be transmitted to the article 9 contained therein to remove the article 9 from the blister package.

It will be appreciated by one of ordinary skill in the art that alternative polymeric or similar materials different from those set forth hereinabove or any other generally compressible, moldable material may be employed in forming the first sheet 2 of the blister package. In general, the material comprising the first sheet 2 should be selected in consideration of the chemical and/or physical attributes of the articles to be contained therein. If desired, the first sheet 2 may comprise an opaque material, thereby preventing the articles 9 contained therein from being viewed or attracting undesired attention. Furthermore, the first sheet 2 may comprise material of appropriate density and opacity as to filter out degradative wavelengths of light, or to protect the articles 9 from inadvertent physical damage attendant to manipulation of the apparatus.

As shown in FIG. 1a, the first sheet 2 has a first side 3 and a second side 4. The first sheet 2 comprises a plurality of generally outwardly extending blister cells 8 for accommodating the preferred articles 9 to be dispensed. As shown in exemplary FIG. 1, the blister cells 8 are preferably disposed evenly about the outer periphery of the first sheet 2. The dimensions of the blister cells 8 are generally complementary with respect to the size and shape of the articles 9 contained therein. The contents, preferably the articles 9 contained in the blister cells 8, preferably comprise pharmaceutical or medicinal products, such as pills, tablets, capsules, syringes, suppositories, and the like. It is, however, to be understood that the contents need not be restricted to products of pharmaceutical or medicinal classifications, but may alternatively comprise electronic and automotive components, such as batteries, transistors, resistors, capacitors, screws, nuts, bolts and the like, or any other contents suitable for packaging in a blister-type package or container. While the instant drawings depict the preferred blister cells 8 as incorporating only a large, single article 9, it is to be further understood that more than one preferred article 9 may contained inside a single blister cell 8. For example, the single medicament cell may incorporate a plurality of small articles, wherein each of the articles is dimensionally appropriate for aggregate accommodation inside the blister cell 8, yet may be dispensed in aggregate from the single blister cell 8. Furthermore, the preferred blister package may incorporate a plurality of blister cells 8 comprising mixtures of both single and multiple articles, in either alternating or random order.

As shown in FIG. 1a, the blister package further comprises a rupturable or puncturable substantially flat second sheet 5. The second sheet 5 is preferably puncturable by the preferred article 9 contained within the area defined by the blister cell 8 when force is applied to an exterior portion of the blister cell 8 of the first sheet 2 and, thereby, to the article 9. One of ordinary skill in the art will appreciate that the pressure required to puncture the second sheet 5 with the preferred article 9 is, inter alia, a necessary function of the shape and compressibility of the article 9, as well as the compressibility, thickness, and types of material from which the first sheet 2 and the second sheet 5 are formed. Normally, the required pressure is that which is capable of being imparted to the first sheet 2 of the blister package by one or more fingers of the individual using the apparatus.

One of ordinary skill in the art will understand that the second sheet 5 need not always be substantially flat, but may have ridges or indentations. Preferably, the second sheet 5 is generally co-extensive with, and conforms generally in size to, the first sheet 2. However, one of ordinary skill in the art will understand that the second sheet 5 may be larger or smaller than the first sheet 2, if desired.

As shown in FIG. 1a, the second sheet 5 has a first side 6 and a second side 7. The first side 6 of the second sheet 5 sealingly engages at least a portion of the first side 3 of the first sheet 2. Such sealing engagement generally does not include the opening defined by the rear of the blister cell 8. Preferably, the first side 6 of the second sheet 5 is heat sealed or adhesively engaged to at least a portion of the first side 3 of the first sheet 2. For purposes of illustrative clarity, the adhesive or heat sealing coating is not shown in the drawings of the instant invention, however, one of ordinary skill in the art will understand that the first side 6 of the second sheet 5 may be sealingly engaged with a portion of the first side 3 of the first sheet 2 by alternative means, such as induction heating, solvent welding, or other methods that will be known, or apparent in light of the disclosure herein, to one of ordinary skill in the art.

The first sheet 2 of the blister package is sealed by the second sheet 5 which serves to retain and protect the preferred articles 9 while they are contained inside the blister cells 8. The second sheet 5 overlies the opening defined by the rear of the blister cell 8, is substantially co-extensive with the first sheet 2, and comprises a material that is generally rupturable or puncturable by the article 9 contained in the blister cell 8 when a force is applied to the outside of the blister. Preferably, the second sheet 5 comprises a metallic foil, such as aluminum foil or similar material, which is applied to the first sheet 2 in a manner such that a protective hermetic seal between the articles 9 contained in the medicament cell 8 and the exterior environment is imparted. It is to be understood, however, that any other conventional material, such as plastic or paper may also be successfully employed.

The preferred blister package is contained in, or on, a housing 1. The housing 1 of the instant apparatus is similar in appearance to a frame member and is preferably formed from a thermoplastic material such as polyvinyl chloride, polystyrene, polypropylene, or any of the other polymeric materials discussed hereinabove which can be used to form the first sheet 2 of the blister package. However, one of ordinary skill in the art will understand that the housing 1 may be formed from any material that is of sufficient rigidity to hold the blister package in place. For example, the housing 1 can be constructed of paperboard, or paperboard with a heat seal coating, or a combination of paperboard and a polymeric material. Each component of the housing 1 may be formed from the same material or different materials as desired. Preferably, the components of the housing 1 may be assembled by heat sealing, RF (radio frequency) or sonic welding, mechanical press fitting, or any other conventional means of assembly known to one of ordinary skill in the art.

The components comprising the housing may be assembled after the blister package has been positioned in, or on, the housing 1. Alternatively, the housing may be designed as a pre-formed unit such that a blister package, acquired separately from the housing 1 but intended to be positioned therein, or thereon, by the user, may be removed when depleted of contents and replaced with a fresh blister package without necessitating the separate steps of disassembling the housing, removing the depleted blister package, substituting a fresh blister package therefor, and reassembling the housing. If the housing 1 comprises such a pre-formed unit, one of ordinary skill in the art would understand that the apparatus should be designed so that the child-resistant attributes of the instant invention are retained. This may be obtained by requiring, inter alia, that the level of physical strength and/or intellectual sophistication necessary to remove and replace the depleted blister package is such that only an adult would be able to perform the requisite operations. Furthermore, although the housing 1 illustrated in the accompanying Figures is depicted in fragmentary perspective as two-piece assemblies comprising separate top and bottom sections, it is to be understood that the housing may comprise any conventional configuration suitable for retaining a medicament dispenser, including a single-piece unit that does not incorporate separate top and/or bottom sections.

As depicted in FIG. 1b, the housing 1 surrounds at least a portion of the preferred blister package, and is sized so as to permit movement thereof within, or about, the housing 1 between a freely rotatable, non-dispensing position and a locked, non-rotating dispensing position. Preferably, the housing 1 surrounds at least a portion of the blister package so that at least a partial view of the positioning and radial alignment of the medicament cells 8 with respect to the housing 1 is presented to the user. The housing 1 further comprises an opening therein defining a dispensing aperture 10 which, when in registry with the medicament cell(s) 8 of the medicament dispenser, permits passage therethrough of the preferred article(s) 9 contained therein when the blister package is in the locked, non-rotating dispensing position.

If desired, the medicament container and/or the housing 1 may further comprise alignment enhancement indices disposed on housing 1 and/or the medicament container that permit the user to correctly ascertain and align the relative positions of the medicament cells 8 of the medicament container and the dispensing aperture 10. If desired, and/or appropriate, the housing 1 and/or the medicament container may further comprise indices designating the dosage regimen(s) to be dispensed, and/or the appropriate times of dosage administration.

As employed throughout the present description and appendant claims, the word “aligned”, or the phrase “in alignment”, when used in connection with the positional relationship of the medicament cell 8 and the dispensing aperture 10, indicates the position wherein, when achieved, both the medicament cell 8 and the dispensing aperture 10 are substantially parallel one with the other, but not in registry one with the other. As employed throughout the instant description and appendant claims, the term “registry” indicates the position which, when achieved, permits dispensation of only the contents contained in a single medicament cell 8 of the medicament container through the dispensing aperture 10. For example, the dispensing aperture 10 is out of registry with a single medicament cell 8 when the medicament container is in the freely rotatable, non-dispensing position, and the medicament cell 8 is in registry with the dispensing aperture 10 when the medicament container has been moved into the locked, non-rotating dispensing position.

One of ordinary skill in the relevant art will appreciate that the dispensing aperture 10 should be sized in a manner appropriate to accommodate the passage therethrough, and dispensation thereof, of all of the contents of a single medicament cell 8. In the exemplary embodiment depicted in FIGS. 1a and 1b, the dispensing aperture 10 comprises an opening in the housing 1 defined generally by a size and shape that is just slightly larger than the dimensions of the preferred article(s) 9 to be dispensed. It is to be understood, however, that the embodiment of the dispensing aperture 10 depicted in FIG. 1a is for purposes of exemplification only, and that the dispensing aperture 10 may comprise any desired shape or size suitable for the passage therethrough, and dispensation thereof, of the contents of a single medicament cell 8, and, moreover, may be disposed at any appropriate, or desired, location in, or on, the housing 1.

The medicament container of the instant apparatus, including the preferred blister package depicted in exemplary FIG. 1a, is adapted to be rotatably mounted in, or on, the housing 1 about a common axis such that a single medicament cell, when depleted of the contents contained therein, may be moved out of registry with the dispensing aperture 10 of the housing 1 by rotational movement of the medicament container with respect to the housing 1 about the common axis. The common axis may comprise any conventional arrangement that permits free rotational movement of the circular, or substantially medicament container about the housing 1, including, for example, a hub or spindle and socket arrangement, or a similar, or a different, means. In the practice of the present invention, the common axis is preferably constructed so as to permit the medicament container to be disengaged therefrom, and moved between the freely rotatable, non-dispensing position and the locked, non-rotating dispensing position.

In the exemplary embodiment of the invention depicted in FIG. 1a, the common axis 11 comprises a substantially flexible spindle member that engages with the center perforation 12 of the preferred blister package, but which is disengageable therefrom, preferably by means of downwardly depending pressure exerted by, for example, a finger of the user. In the exemplary embodiment shown in FIG. 1a, the common axis 11 comprises a spindle member constructed integrally with, or comprising an excised segment of, the bottom section 1b of the housing. The operational steps of disengaging the blister package from the common axis 11, moving the blister package into the dispensing position, and dispensing the articles 9 contained therein through the dispensing aperture 10, are depicted sequentially in FIG 1b. For purposes of illustrative clarity, the top section 1a of the housing 1 has been omitted from the aforementioned FIG 1b.

If desired, the common axis 11 and/or the housing 1 may further comprise means for limiting the rotation of the medicament container in a single direction. Such means may comprise, for example, ratchet teeth or similar means that permit the medicament container to rotate in a single, pre-determined direction, but not in an opposite direction, for example, an arrangement permitting clockwise, but not counter-clockwise, rotation of the medicament container. Examples of means for limiting the rotation of a medicament container in a single direction about a common axis will be well-known to one skilled in the relevant art. See, for example, U.S. Pat. No. 5,464,118, the disclosure of which is incorporated herein by reference in its entirety. If such means are incorporated into the apparatus, one of ordinary skill in the art will appreciate that such means should provide for the incremental movement, with concomitant proper alignment and/or registry thereof, of a single medicament cell 8 of the medicament container with the dispensing aperture 10 such that when the medicament container is in the locked, non-rotating dispensing position, the medicament cell 8 is properly registered over the dispensing aperture 10, thereby permitting the preferred article(s) 9 to be correctly, and completely, dispensed therethrough. In the exemplary embodiment shown in FIG. 1a, the common axis 11 incorporates means for providing incremental movement of the preferred blister package which comprise a nub 13 disposed along the inner periphery of the center perforation 12 of the blister package, that frictionally engages with corresponding notches 14 disposed along the outer periphery of the spindle member.

The teachings hereinabove describing the common axis of the instant apparatus are to be considered exemplary only, and are not to be construed as limitations thereon as other embodiments are, or will be, known or apparent in light of the instant disclosure, to one of ordinary skill in the art, including the alternative embodiments described in specific detail hereinbelow.

As depicted in exemplary FIGS. 1a and 1c, the apparatus further comprises means for locking the medicament container while in the locked, non-rotating dispensing position, thereby preventing rotation thereof about the common axis 11. In the exemplary embodiment depicted in FIG. 1a, such locking means comprises at least one, but preferably a plurality of, projections 15 disposed on, or formed integrally with, the top section 1a of the housing 1 wherein the projections 15 conform generally in shape and size to the outer periphery of at least one, but preferably a plurality, of the blister cells 8 of the preferred blister package. When the preferred blister package has been moved into the locked, non-rotating dispensing position, at least one, but preferably a plurality, of the projections 15 physically engage at least one of the blister cells 8 of the blister package such that rotation of the blister package about the common axis 11 is blocked. By so engaging, the dispensation of more than one of the preferred article(s) 9 from a single blister cell 8 through the dispensing aperture 10 in a single operation of the apparatus is prevented. In order to dispense additional articles 9, the blister package is moved from the locked, non-rotating dispensing position into the freely rotatable, non-dispensing position such that the depleted blister cell is out of registry with the dispensing aperture 10. The preferred blister package is then rotated about the common axis 11 until another blister cell 8, containing fresh contents to be dispensed, is aligned with the dispensing aperture 10. The blister package is then moved back into the locked, non-rotating dispensing position, and a fresh article 9 is dispensed therefrom.

It is to be understood that the locking means may also be disposed on, or formed integrally with, both the medicament container and/or the housing. If the locking means is/are disposed on both the housing and the medicament container, one of ordinary skill in the art will appreciate that both such locking means should be disposed in a cooperative relationship one with the other such that a secure lock of the medicament container and the housing is enabled when the medicament container has been placed in the locked, non-rotating dispensing position.

The teachings hereinabove describing the locking means of the instant apparatus are for purposes of exemplification only, and are not to be construed as limitations thereon as other embodiments are, or will be, known or apparent in light of the instant disclosure, to one of ordinary skill in the art, including the alternative embodiments described hereinbelow.

1st Alternative Embodiment Description

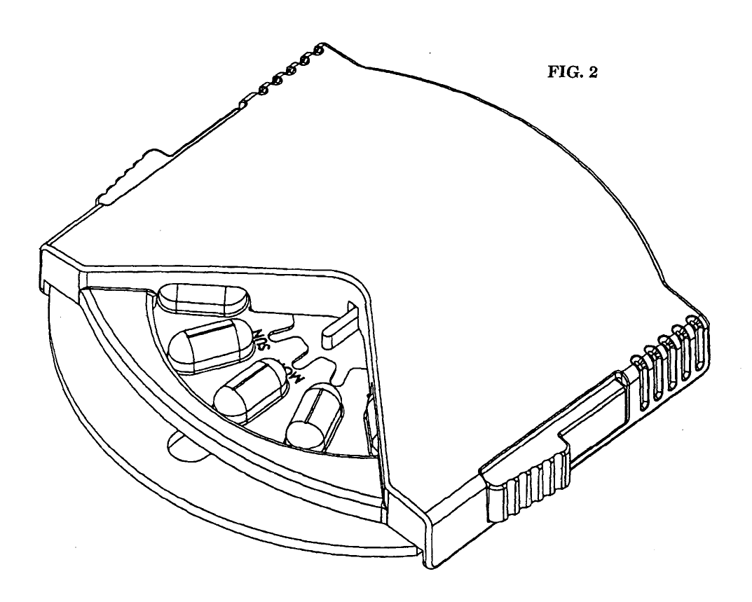

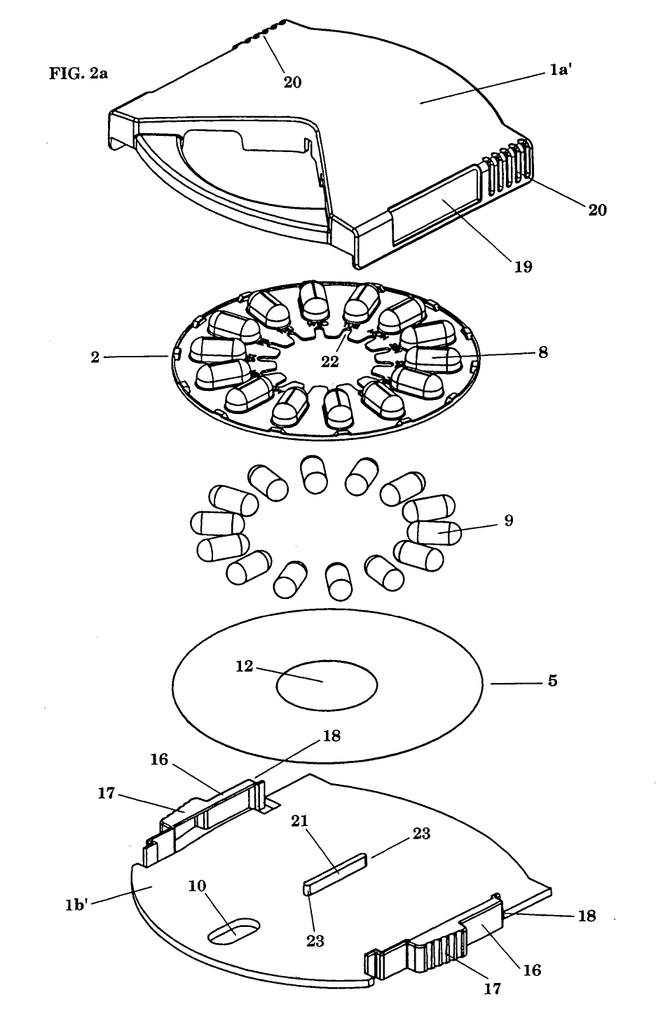

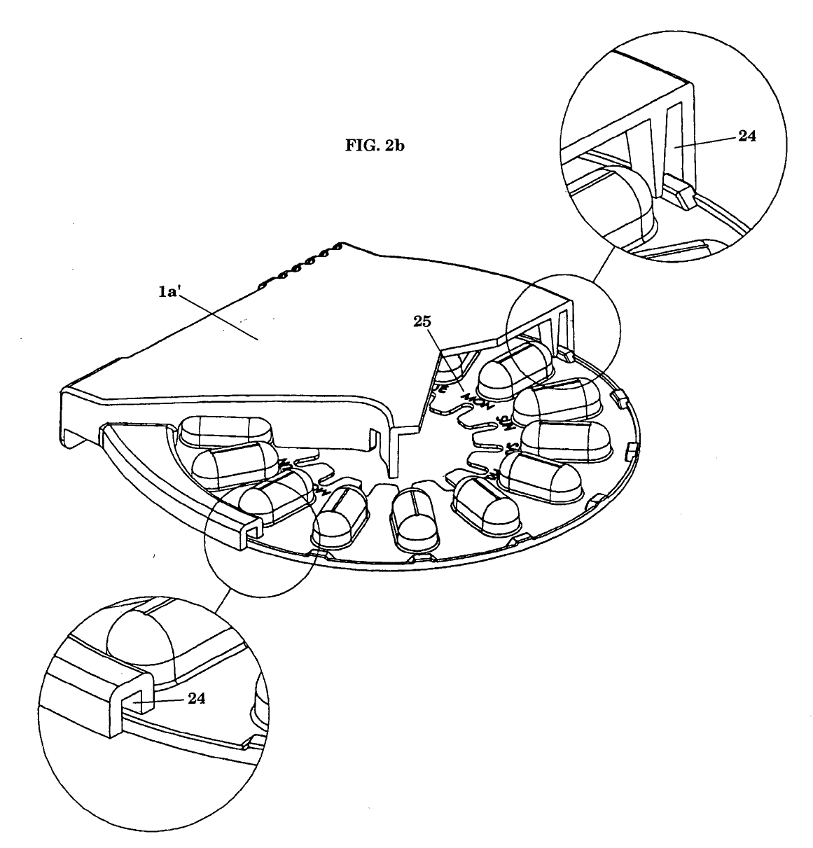

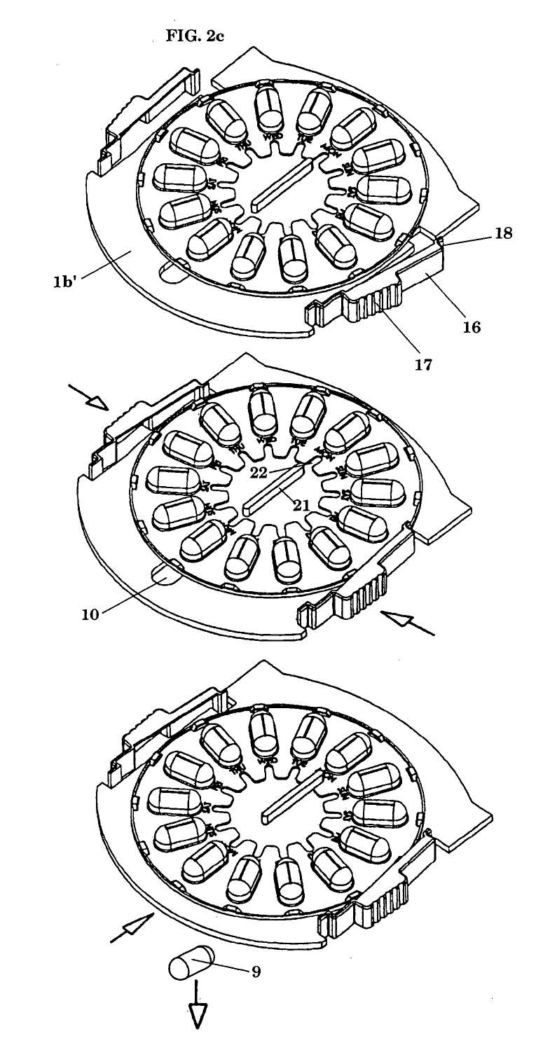

A first alternative embodiment of the invention is depicted in FIGS. 2, 2a, 2b, and to 2c, wherein the medicament container is retained within the housing and comprises a substantially circular blister package having a central perforation 12. The operational steps of the manipulation of this alternative embodiment are depicted in FIG. 2c.

As shown in FIG. 2a, the housing of the first alternative embodiment comprises separate top 1a′ and bottom 1b′ sections, wherein the bottom section 1b′ comprises substantially flexible locking tabs 16 that permit the blister package, retained in the top 1a′′section of the housing, to be moved between the freely rotatable, non-dispensing position and the locked, non-rotating dispensing position. As depicted in FIG. 2b, the blister package is retained within the top 1a′ section of the housing by an annular rotation guide 24 which interlocks with the outer periphery of the blister package. The bottom 1b′ section of the housing further comprises a dispensing aperture 10. Each of the interlocking tabs comprises pressure-bearing surfaces 17 and lock stops 18 and is captively-retained and laterally movable within the area defined by elongate openings 19 located along the sidewalls of the top 1a′ section of the housing. The top 1a′ section of the housing further comprises a plurality of vertical ridges 20 that facilitate finger gripping of the apparatus during operation.

In the first alternative embodiment, the common axis and means for locking the medicament container comprise a congruently functional raised rib 21 and slot 22 arrangement, wherein the raised rib 21 comprises opposing end portions 23. The length of the raised rib 21 is just slightly less than the diameter of the center perforation 12 of the blister package, thereby permitting free rotation of the blister package while in the freely rotatable, non-dispensing position. In a complimentary manner, the central perforation 12 of the blister package has a diameter just slightly larger than the length of the raised rib 21 thereby permitting free rotation of the medicament container thereabout while in the freely rotatable, non-dispensing position. The plurality of slots 22, disposed along the inner periphery of the center perforation 12 of the first sheet 2 of the blister package, are sized appropriately so as to receive an end portion 23 of the raised rib 21 when the blister package has been moved into the locked, non-rotating dispensing position.

The operational steps showing movement of the blister package from the freely-rotating, non-dispensing position, movement of the blister package into the locked, non-rotating dispensing position, and dispensation of the preferred article 9 contained therein through the dispensing aperture 10, are depicted sequentially in FIG. 2c. For purposes of illustrative clarity, the top 1a′ section of the housing has been omitted from FIG. 2c.

The blister package is moved from the freely rotatable, non-dispensing position into the locked, non-rotatable dispensing position by first rotating the blister package inside the housing until a single medicament cell 8 and the dispensing aperture 10 have been brought into alignment. As an aid to proper alignment and dispensation of the preferred articles 9, the blister package of the first alternative embodiment further comprises alignment indices 25 in the form of abbreviations for days of the week when dosages are to be dispensed. Secondly, once proper alignment has been achieved, pressure is imparted simultaneously to each of the pressure-bearing surfaces 17 of the interlocking tabs 16 of the bottom section 1b′ of the housing, thereby uncoupling the lock stops 18 from rear of the elongate openings 19 of the top section 1a′ of the housing, and permitting both top 1a′ and bottom 1b′ sections of the housing to be laterally displaced with respect to one another. This operation results in the disengagement of the blister package from the common axis, such that they are no longer superimposed. Upon complete lateral displacement, the medicament cell 8 of the blister package is both in registry with the dispensing aperture 10, allowing the preferred article 9 to be dispensed therethrough, and secured in the non-rotating dispensing position by virtue of the interlock between the raised rib 21 and slot 22. The blister package may be restored to the freely rotatable, non-dispensing position by simply re-superimposing the top 1a′ and bottom 1b′ sections of the housing such that the interlocking tabs 16 are recoupled with the elongate opening 19.

2nd Alternative Embodiment Description

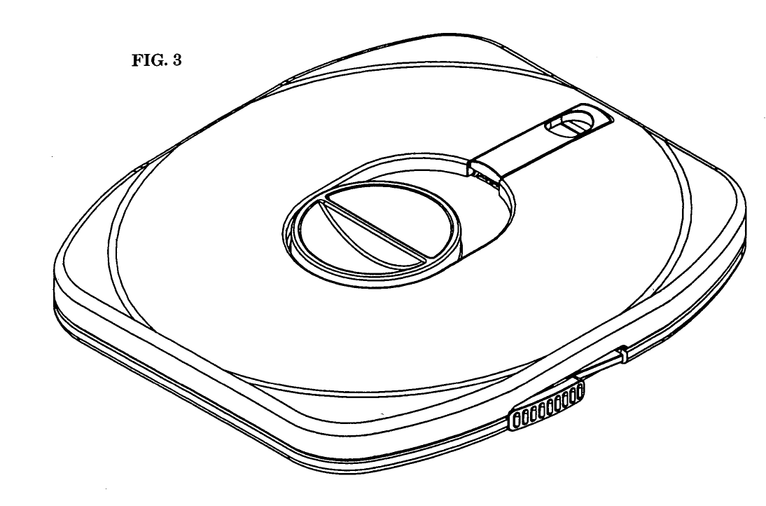

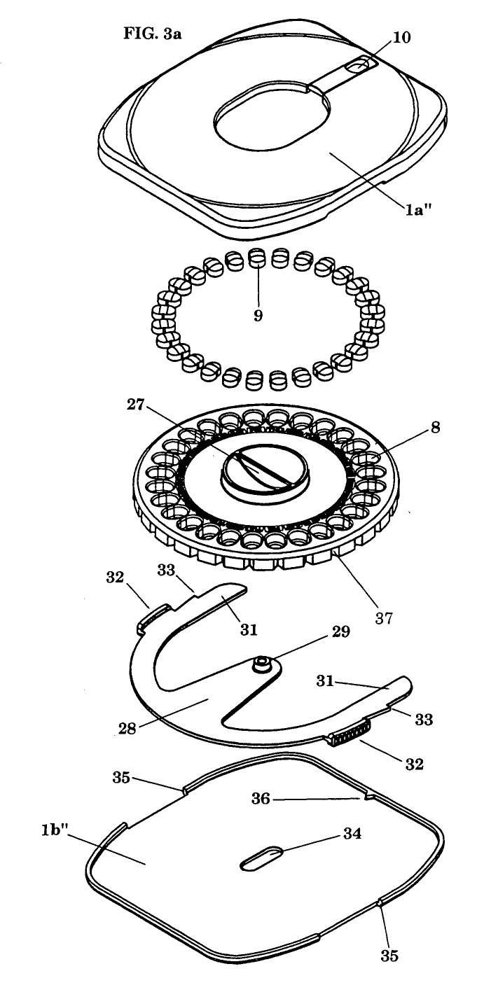

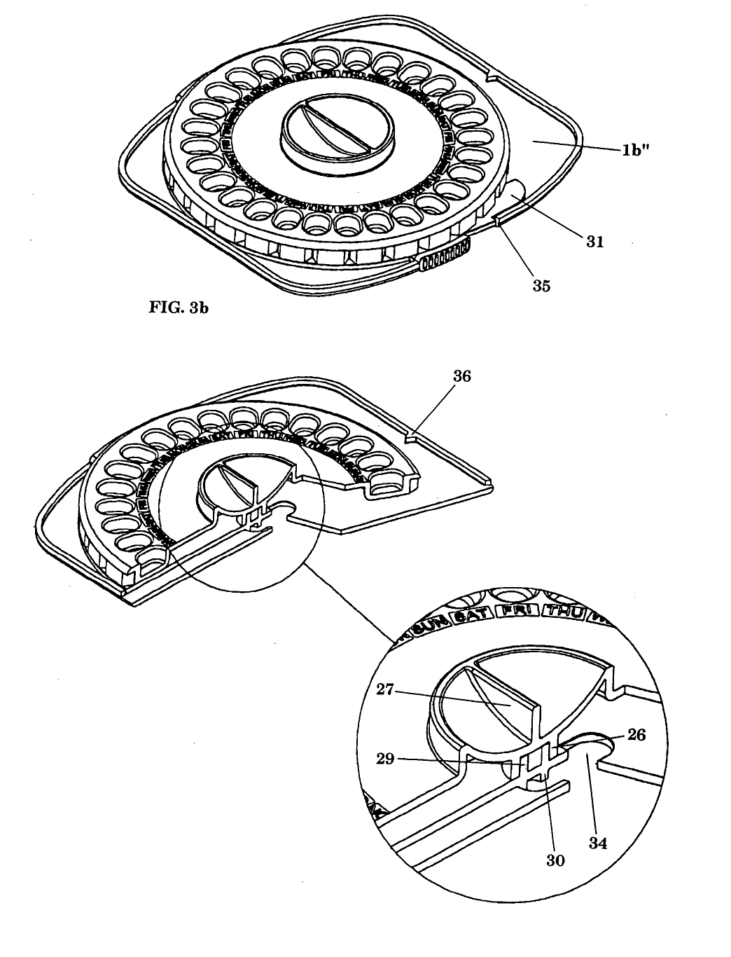

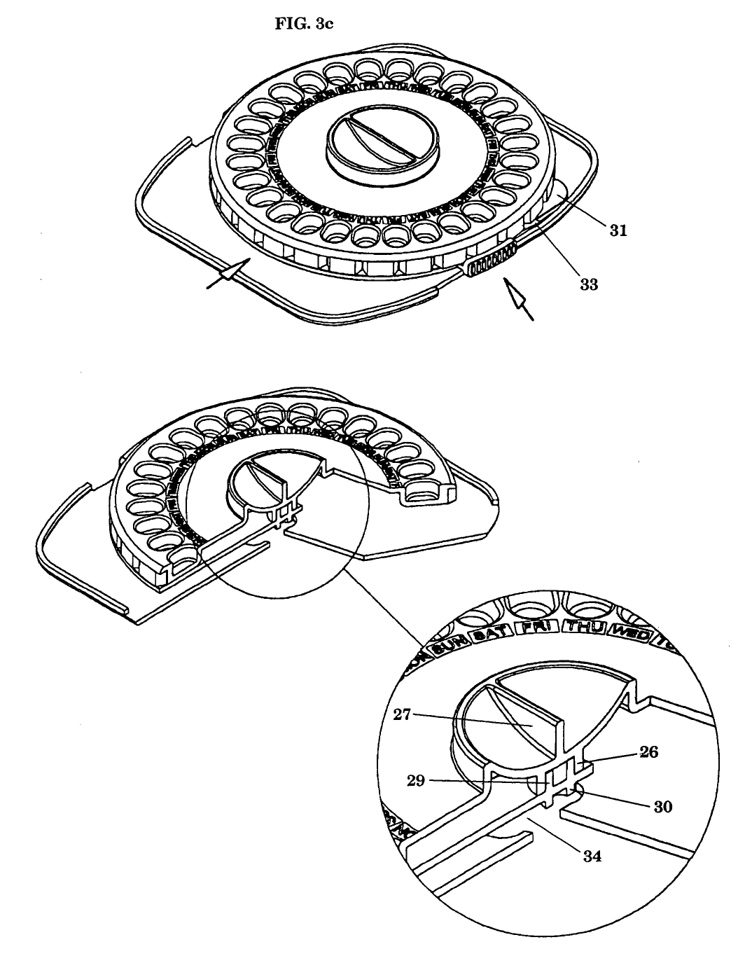

A second alternative embodiment of the invention is depicted in FIGS. 3, 3a, 3b, and 3c, wherein the substantially circular medicament container comprises a plurality of unsealed medicament cells 8 containing articles 9 to be dispensed, a spindle 26 having a female end portion, and rotating means 27. The medicament container is rotated about the housing by manual manipulation of the rotating means 27, normally by the fingers of the user, so that the medicament cells 8 of the medicament container are brought into alignment with the dispensing aperture 10.

The means for locking the medicament container comprises a substantially flexible, bifurcate abutment member 28 comprising top 29 and bottom 30 male end portions and arms 31, each arm having pressure-bearing surfaces 32 and abutment faces 33. As depicted in FIG. 3b, the medicament container is affixed to the abutment member 28 and the bottom section 1b″ of the housing by mating the female end portion of the spindle 26 with the top male end portion 29 of the abutment member 28, and an elongate slot 34 in the bottom section 1b″ of the housing with the bottom male end portion 30 of the abutment member 28. Affixing the medicament container with the abutment member 28 and the bottom section 1b″ of the housing in such a manner provides the common axis about which the medicament container and the housing may be rotated.

The housing of the embodiment shown in FIG. 3a comprises a top 1a″ section having a dispensing aperture 10, and a bottom 1b″ section having an elongate slot 34. The separate top and bottom sections, when integrated to form the housing, retain both the medicament container and the abutment member 28 therein. The integrated housing further comprises cutouts having sidewalls 35 disposed in an operative relationship with the abutment faces 33 of the arms 31. When the integrated medicament container and abutment member 28 are in the freely rotatable, non-dispensing position, the abutment faces 33 of the arms 31, by virtue of their contact with the sidewalls 35, prevent movement within the housing of the medicament dispenser between the freely rotatable, non-dispensing position and the locked, non-rotating dispensing position. In the second alternative embodiment shown in FIG. 3a, means are provided for locking the medicament container while in the locked, non-rotating dispensing position which comprise a projection 36 disposed along the rear wall of the bottom 1b″ section of the housing and a plurality of locking recesses 37 disposed along the outer periphery of the medicament container. When the medicament container is in the freely rotatable, non-dispensing position, both the projection 36 and the recesses 37 are out of engagement. However, once the medicament container has been moved into the locked, non-rotating, dispensing position, the projection 36 is fully inserted into one of the recesses 37, thereby precluding any rotation of the medicament container about the common axis.

The operational steps of the manipulation of the second alternative embodiment are depicted in FIGS. 3b and 3c.

The medicament container is first rotated using the rotating means 27 until a single medicament cell 8 thereof is brought into alignment with the dispensing aperture 10. The medicament container is then moved from the freely rotatable, non-dispensing position into the locked, non-rotating dispensing position by next simultaneously applying pressure, preferably with the thumb and forefinger of the user, to both of the pressure-bearing surfaces 32 of the arms 31 so that the abutment faces 33 of the arms 31 and the sidewalls 35 of the housing are disengaged. The pressure-bearing surfaces 32 are subsequently pushed in a forward direction such that a single medicament cell 8 of the medicament container and the dispensing aperture 10 are brought into registry. The article 9 in the single medicament cell 8 of the medicament container may now be dispensed, most conveniently, by inverting the dispenser, thereby allowing the article 9 to fall therefrom. The medicament container may now be moved from the locked, non-rotating, dispensing position back into the freely rotatable, non-dispensing position by simply pushing either the rotating means 27, or the pressure-bearing surfaces 32, in a backward direction so that the single, depleted medicament cell 8 and the dispensing aperture 10 are brought out of registry, and the abutment faces 33 of the arms 31 and the sidewalls 35 of the housing are reengaged.

The teachings hereinabove regarding the construction and operation of the instant apparatus are for purposes of exemplification only, and are not to be construed as limitations thereon as other embodiments are, or will be, known or apparent in light of the instant disclosure, to one of ordinary skill in the art.

1. An apparatus comprising:
a housing for retaining a circular, or substantially circular, medicament container and;
a circular, or substantially circular, medicament container retained by said housing and rotatable with respect thereto about a common axis while in a freely rotatable, non-dispensing position wherein:
said housing surrounds at least a portion of said medicament container and comprises a single dispensing aperture and means for locking said medicament container in a locked, non-rotating, dispensing position; and
said medicament container comprises a plurality of medicament cells and is moveable between said freely rotatable, non-dispensing position and said locked, non-rotating dispensing position such that when said medicament container is in said freely rotatable, non-dispensing position, said medicament cells are out of registry with said dispensing aperture, and when said medicament container is in said locked, non-rotating dispensing position, a single medicament cell and said dispensing aperture and are in registry such that only contents contained in said single medicament cell may be dispensed therethrough.

2. The apparatus of claim 1 wherein said medicament cells contain articles to be dispensed.

3. The apparatus of claim 1 wherein said medicament container comprises a blister package with a plurality of blister cells having articles to be dispensed.

4. The apparatus of claim 1 wherein said means for locking said medicament container comprises means for engaging said medicament container.

5. The apparatus of claim 1 wherein said medicament container comprises a blister package having a plurality of blister cells, and said means for locking said medicament container comprises means for engaging at least one blister cell of said medicament container.
